(19) United States
(12) Patent Application Publication
(10) Pub. No.: US 2025/0209596 A1
(43) Pub. Date: Jun. 26, 2025

(54) DEFORMATION COMPOSITION DATA GENERATION APPARATUS AND DEFORMATION COMPOSITION DATA GENERATION METHOD

(71) Applicant: NEC Corporation, Minato-ku, Tokyo (JP)

(72) Inventors: Tatsuya Sumiya, Tokyo (JP); Jiro Abe, Tokyo (JP); Kazumine Ogura, Tokyo (JP)

(73) Assignee: NEC Corporation, Minato-ku, Tokyo (JP)

(21) Appl. No.: 18/851,798

(22) PCT Filed: Apr. 13, 2022
(86) PCT No.: PCT/JP2022/017663

§ 371 Date: Sep. 27, 2024

(51) Int. Cl. G06T 7/00

(52) U.S. Cl. CPC G06T 7/0004; G06T 2207/10028; G06T 2207/20081; G06T 2207/30184

(57) ABSTRACT

In the deformation composition data generation apparatus which is implemented by one or more processors, an acquisition unit acquires a distribution of amount of displacement for points in point cloud data, and a composition unit composes the amount of displacement to the points in the point cloud data according to the distribution.

### TECHNICAL FIELD

This invention relates to a deformation composition data generation apparatus and a deformation composition data generation method, and a deformation composition data generation program, in particular to a deformation composition data generation apparatus and deformation composition data generation method, and a deformation composition data generation program for generating point cloud data with damage and other deformities.

### BACKGROUND ART

Improving the efficiency of inspection operations for infrastructure facilities such as bridges, tunnels, or concrete buildings is a problem in society. Attempts are being made to apply machine learning, or deep learning, to detect cracks, delaminations, exposed rebar, and other damage and other deformities.

Generally, the application of machine learning or deep learning requires preparation of a large number of training data. Since preparing a large number of training data from no source data is costly, techniques have been devised to artificially generate new training data from existing data.

Images are often used as measurement information in the analysis of deformations as described above. As measurement information other than images, point cloud data acquired by LIDAR (Light Detection And Ranging) and other methods are also attracting attention. Point cloud data retains the coordinates of the 3D space as they are. Therefore, point cloud data is considered to be more effective information for analyzing deformations including three-dimensional variation.

Non-patent literature 1 also describes a technique for generating a variety of pseudo-crack images like real data from annotated images of cracks using Generative Adversarial Network (GAN) which is a type of deep learning model.

Non-patent literature 2 also describes a technique for generating a variety of training data by extracting objects to be detected from an image and pasting the extracted objects onto other images.

Non-patent literature 3 describes a technique for extracting geometric structures such as planes and cylinders from point cloud data by random sample consensus (RANSAC).

Non-patent literature 4 also describes technology related to PointNet++, a type of deep learning network that uses point cloud data as input.

### CITATION LIST

### Non-Patent Literature

NPL 1: Tomotaka Fukuoka, Takahiro Minami, Wataru Urata, Makoto Fujio, Junichi Takayama, “A Data Augmentation with Pix2Pix for Deep Learning Method for Detecting Crack on an Actual Concrete”, Journal of JSCE, F4 (Construction Management), Vol. 75, No. 2, I_27-I_35, 2019.
NPL 2: Debidatta Dwibedi, Ishan Misra, and Martial Hebert, “Cut, paste and learn: Surprisingly easy composition (synthesis) for instance detection,” In Proceedings of the IEEE International Conference on Computer Vision, pages 1301-1310, 2017.
NPL 3: R. Schnabel, R. Wahl, and R. Klein, “Efficient RANSAC for point-cloud shape detection,” In Computer Graphics Forum, Citeseer, vol. 26, pages 214-226, 2007.
NPL 4: C. R. Qi, L. Yi, H. Su, and L. J. Guibas, “PointNet++: Deep hierarchical feature learning on point sets in a metric space,” In Advances in Neural Information Processing Systems (NIPS), 2017.

### SUMMARY OF INVENTION

### Technical Problem

The scope of application of the training data generation technique described in Non-patent literature 1 which uses the generative adversarial network (GAN) being a type of deep learning model is limited to images. In other words, it is difficult to apply the learning data generation technique described in Non-patent literature 1 to point cloud data.

In general, the development of machine learning or deep learning techniques for point cloud data is not as advanced as the development of machine learning or deep learning techniques for images. Therefore, it is considered difficult to extend the technology for generating training data using GAN, which is a type of deep learning model, to be applicable to point cloud data.

The training data generation technique described in Non-patent literature 2 is a technique for pasting extracted target objects, such as foodstuffs, onto other images, and does not use machine learning or deep learning.

However, it is difficult to apply the training data generation technique described in Non-patent literature 2 to the generation of deformations. The reason is that a deformation is not the object itself but a variation of a part of the object, and it is difficult to express it simply by placing the object.

FIG. 18 is an explanatory diagram showing an example of point cloud data with deformations and point cloud data without deformations. The point cloud data shown in FIG. 18 represents girders of bridges and ceilings of buildings.

The point cloud data shown in the upper part of FIG. 18 is point cloud data without deformations. The point cloud data shown in the lower part of FIG. 18 is point cloud data with deformations. The difference between the two point cloud data shown in FIG. 18 includes variation, i.e., point movement. It is difficult to represent movement of points in terms of the arrangement of objects.

Non-patent literatures 3 to 4 do not describe generating training data from point cloud data.

Therefore, one of the purposes of the present invention is to provide a deformation composition data generation apparatus and a deformation composition data generation method, and a deformation composition data generation program which can generate new data with deformations even if the data format is a point cloud.

### Solution to Problem

The deformation composition data generation apparatus according to the present invention includes n acquisition unit which acquires a distribution of amount of displacement for points in point cloud data, and a composition unit which composes the amount of displacement to the points in the point cloud data according to the distribution.

The deformation composition data generation method according to the present invention includes acquiring a distribution of amount of displacement for points in point cloud data, and composing the amount of displacement to the points in the point cloud data according to the distribution.

The deformation composition data generation program according to the present invention causes a computer to execute acquiring a distribution of amount of displacement for points in point cloud data, and composing the amount of displacement to the points in the point cloud data according to the distribution.

### Advantageous Effects of Invention

According to the present invention, even if the data format is a point cloud, it is possible to generate new data with deformations.

### BRIEF DESCRIPTION OF DRAWINGS

FIG. 1 It depicts a block diagram showing a configuration example the deformation composition data generation apparatus of the first example embodiment of the present invention.

FIG. 2 It depicts an explanatory diagram showing an example of the plane represented by a plane equation calculated by the structure modeling unit 120.

FIG. 3 It depicts a block diagram showing a configuration example the deformation feature data generation apparatus of the first example embodiment of the present invention.

FIG. 4 It depicts an explanatory diagram showing an example of a deformation feature generated by the deformation feature data generation apparatus 200.

FIG. 5 It depicts an explanatory diagram showing another example of a deformation feature generated by the deformation feature data generation apparatus 200.

FIG. 6 It depicts an explanatory diagram showing an example of a composition of deformation feature by the deformation feature composition unit 140.

FIG. 7 It depicts a flowchart showing an operation of the deformation feature composition process by the deformation composition data generation apparatus 100 of the first example embodiment.

FIG. 8 It depicts a block diagram showing a configuration example the deformation composition data generation apparatus of the second example embodiment of the present invention.

FIG. 9 It depicts a flowchart showing an operation of the deformation feature composition process by the deformation composition data generation apparatus 101 of the second example embodiment.

FIG. 10 It depicts a block diagram showing a configuration example the deformation composition data generation apparatus of the third example embodiment of the present invention.

FIG. 11 It depicts an explanatory diagram showing an example of a cylinder handled as a geometric structure by the deformation composition data generation apparatus 102.

FIG. 12 It depicts an explanatory diagram showing an example of a projection of points belonging to a selected range onto a geometric structure by the structure modeling unit 121,

FIG. 13 It depicts a flowchart showing an operation of the deformation feature composition process by the deformation composition data generation apparatus 102 of the third example embodiment.

FIG. 14 It depicts a block diagram showing a configuration example the deformation composition data generation apparatus of the fourth example embodiment of the present invention.

FIG. 15 It depicts a flowchart showing an operation of the deformation feature composition process by the deformation composition data generation apparatus 103 of the fourth example embodiment.

FIG. 16 It depicts an explanatory diagram showing an example of the hardware configuration of the deformation composition data generation apparatus according to the present invention.

FIG. 17 It depicts a block diagram showing an overview of the deformation composition data generation apparatus according to the present invention.

FIG. 18 It depicts an explanatory diagram showing an example of point cloud data with deformations and point cloud data without deformations.

### DESCRIPTION OF EMBODIMENTS

Hereinafter, example embodiments of the present invention will be explained with reference to the drawings. The deformation in each example embodiment represents a change in condition, such as a damage of cracks, etc. or breakage, etc.

### Example Embodiment 1

### Description of Configuration

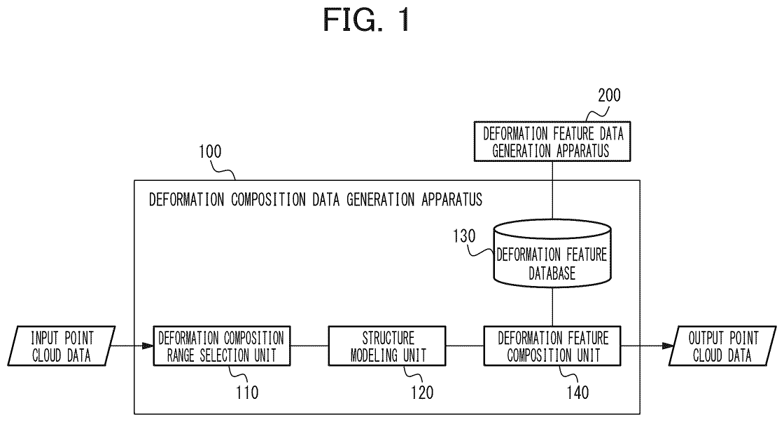

FIG. 1 is a block diagram showing a configuration example the deformation composition data generation apparatus of the first example embodiment of the present invention. The deformation composition data generation apparatus 100 shown in FIG. 1 comprises a deformation composition range selection unit 110, a structure modeling unit 120, a deformation feature database 130, and a deformation feature composition unit 140.

As shown in FIG. 1, the deformation feature database 130 is communicatively connected to a deformation feature data generation apparatus 200. The deformation feature database 130 may not be connected to the deformation feature data generation apparatus 200.

A point cloud, which is a data format to be processed by the deformation composition data generation apparatus 100 shown in FIG. 1, is a set of points with coordinates. Hereinafter, the coordinates are assumed to be 3-dimensional orthogonal coordinates (x, y, z). However, the coordinates that the points have may be expressed in a coordinate system other than an orthogonal coordinate system, such as a polar coordinate system.

The deformation composition data generation apparatus 100 of this example embodiment takes the point cloud data subject to deformation compositing as input data and outputs data obtained by composing deformation to the input data. The input data does not necessarily have a deformation.

The deformation composition data generation apparatus 100 is characterized in that it composes (synthesizes) deformations for a part having a planar structure. The planar structure need not necessarily be a strictly mathematically defined plane, as long as the structure is determined to be planar as a result of the process of estimating that it is planar, as described below.

The deformation composition range selection unit 110 has a function of selecting a range (set of points) for deformation composition to be performed on the input point cloud data. The deformation composition range selection unit 110 selects a range where deformation composition is applied to a manually identified planar structure using point cloud processing software, for example.

Alternatively, the deformation composition range selection unit 110 may select a range where deformation composition is applied to the planar structure extracted using the RANSAC-based algorithm described in Non-patent literature 3. The deformation composition range selection unit 110 inputs the input original point cloud data and the selected range to the structure modeling unit 120.

The structure modeling unit 120 has a function of modeling the selected range input from the deformation composite range selection unit 110 in a plane. Specifically, the structure modeling unit 120 calculates a plane equation through which the points belonging to the selected range input from the deformation composite range selection unit 110 pass.

The structure modeling unit 120 can calculate a plane equation by solving an optimization problem using the least-squares method, for example. The structure modeling unit 120 calculates the following equation (1), for example, as a plane equation.

$$[ Math 1 ]$$

$$ax + by + cz + d = 0 \qquad equation ( 1 )$$

The girders of many bridges and the ceilings of many structures are approximately parallel to the ground. In addition, the walls, etc. of many structures are approximately perpendicular to the ground. The structure modeling unit 120 may use each of the above facts to simplify the calculation of the plane equations.

If the plane equation has already been calculated, such as when the deformation composite range selection unit 110 extracts the plane structure, the structure modeling unit 120 may omit the process of calculating the plane equation.

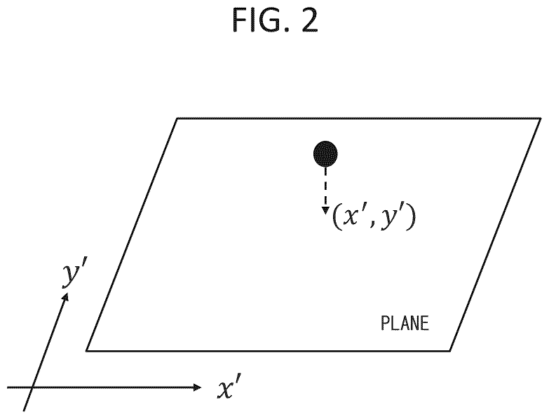

FIG. 2 is an explanatory diagram showing an example of the plane represented by a plane equation calculated by the structure modeling unit 120. Next, the structure modeling unit 120 takes x′ and y′ axes, which constitute an orthogonal coordinate system, on the plane represented by the calculated plane equation, as shown in FIG. 2, respectively. The structure modeling unit 120 can obtain the x′ and y′ axes as axes representing two directions orthogonal to the normal direction (a, b, c), respectively.

When the plane represents a wall of a structure, etc., the structure modeling unit 120 may determine the x′ axis and the y′ axis based on the predefined rule of taking the x′ axis in the direction horizontal to the ground and the y′ axis in the direction vertical to the ground, respectively.

When the plane represents a girder of a bridge or the like, the structure modeling unit 120 may obtain the results based on the predefined rule of taking the x′ axis in the direction of travel of the bridge and the y′ axis in the direction vertical to the direction of travel, respectively.

After obtaining the x′ and y′ axes, the structure modeling unit 120 calculates the (x′, y′) coordinates for each point (black circles shown in FIG. 2) belonging to the selected range when the point is projected onto a plane as shown in FIG. 2. The structure modeling unit 120 inputs the input original point cloud data, the calculated plane equation, and the (x′, y′) coordinates of each point belonging to the selected range to the deformation feature composition unit 140.

The deformation feature database 130 has a function of storing deformation features to be composed. A deformation feature is a feature amount of the deformation when focusing on a predetermined feature of one deformation. For example, the function d(x′, y′) described below is a deformation feature when focusing on displacement as a predetermined feature.

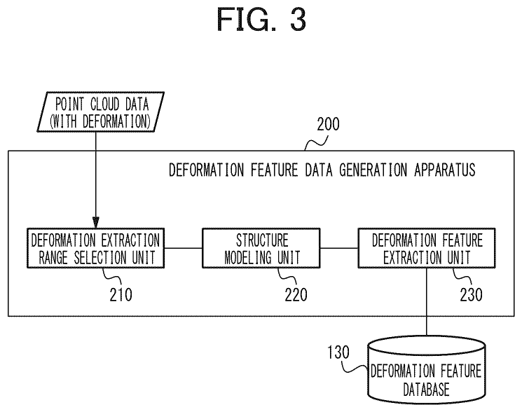

A deformation feature is generated by the deformation feature data generation apparatus 200 shown in FIG. 3, for example. FIG. 3 is a block diagram showing a configuration example the deformation feature data generation apparatus of the first example embodiment of the present invention.

The deformation feature data generation apparatus 200 shown in FIG. 3 comprises a deformation extraction range selection unit 210, a structure modeling unit 220, and a deformation feature extraction unit 230. The deformation feature data generation apparatus 200 takes point cloud data with deformations as input and stores the extracted deformation feature in the deformation feature database 130.

The deformation extraction range selection unit 210 selects a region of planar structure that includes the deformation to be used for composition from the input point cloud data with deformations. The region of planar structure may be selected by the user using point cloud processing software.

When label information is attached to the deformation location, the deformation extraction range selection unit 210 may combine the label information with the extraction of planar structures using the RANSAC-based algorithm described in Non-patent literature 3 to select a region of the planar structure. The deformation extraction range selection unit 210 inputs the input original point cloud data and the selected range to the structure modeling unit 220.

Similar to the structure modeling unit 120, the structure modeling unit 220 calculates a plane equation through which the points belonging to the selected range input from the deformation extraction range selection unit 210 pass. Next, the structure modeling unit 220 calculates the (x′, y′) coordinates of the point belonging to the selected range when the point is projected onto the plane represented by the calculated plane equation. Next, the structure modeling unit 220 inputs the calculated plane equation and the (x′, y′) coordinates of each point belonging to the selected range to the deformation feature extraction unit 230.

The deformation feature extraction unit 230 constructs a function d(x′, y′) that represents the relationship between the (x′, y′) coordinates and an amount of displacement from the plane based on the input from the structure modeling unit 220. The deformation feature extraction unit 230, for example, defines the amount of displacement as a signed distance from the plane, and then calculates the function d(x′, y′) using the original coordinates (x, y, z) as in equation (2) below.

$$[ Math 2 ]$$

$$d ( {x}^{′} , {y}^{′} ) = \frac{ax + by + cz + d}{\sqrt{{a}^{2} + {b}^{2} + {c}^{2}}} \qquad equation ( 2 )$$

The deformation feature extraction unit 230 can construct a function d(x′, y′) defined in a continuous region by interpolating d(x′, y′) obtained from points belonging to the selected range by nearest neighbor interpolation, etc.

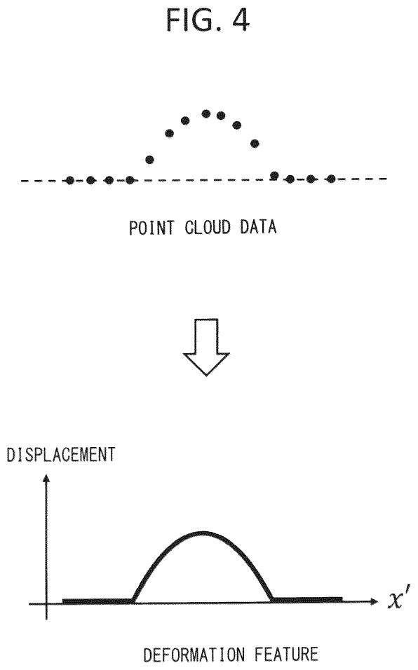

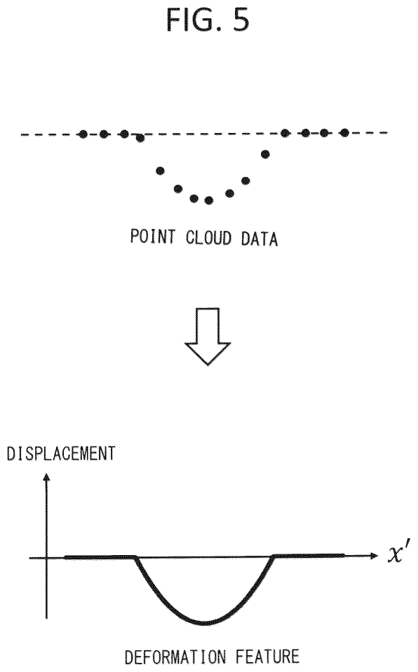

FIGS. 4 and 5 are explanatory diagrams showing examples of a deformation feature generated by the deformation feature data generation apparatus 200. The upper part of FIGS. 4 and 5 shows point cloud data with deformations that are input to the deformation extraction range selection unit 210.

The lower part of FIGS. 4 and 5 shows the function d(x′, y′) which is composed by the deformation feature extraction unit 230. It should be noted that FIGS. 4 and 5 show only the x′ direction. As shown in FIGS. 4 and 5, in this example embodiment, the information of the distribution of amount of displacement, expressed as the function of (x′, y′), from the plane parallel to the x′ axis shown in FIGS. 4 and 5, is treated as a deformation feature,

The deformation feature shown in FIG. 4 is a deformation feature generated from point cloud data with an “uplift” deformation. The deformation feature shown in FIG. 5 is a deformation feature generated from point cloud data with a “subsidence” deformation.

When each point has label information, which is information such as presence or absence of deformation, a type of deformation, a scale of deformation or the like, it is preferable that the composition is performed including the label information. When each point has label information, the deformation feature extraction unit 230 defines the function L(x′, y′) representing the label information in the same way as the function d(x′, y′), using interpolation, etc.

Examples of the type and scale of deformation include, for example, the classification of damage such as cracks, delamination/exposed rebar, and cracks, as well as the judgment classification indicating the degree of damage, as defined by Japanese Ministry of Land, Infrastructure, Transport and Tourism's Guidelines for Periodic Inspection of Road Bridges.

The deformation feature extraction unit 230 stores the functions d(x′, y′) and L(x′, y′) obtained as described above in the deformation feature database 130 as a deformation feature.

Instead of being generated based on existing point cloud data with deformations by the deformation feature data generation apparatus 200, the deformation features stored in the deformation feature database 130 may be defined by a mathematical formula based on a model of some geometric structure. For example, when the model is based on an ellipsoid, the function d(x′, y′) may be defined by the following equation (3).

$$[ Math 3 ]$$

$$d ( {x}^{′} , {y}^{′} ) = \{ \begin{matrix}{d}_{0} \sqrt{1 - {( {x}^{′} / {l}_{x} )}^{2} - {( {y}^{′} / {l}_{y} )}^{2}} \\ 0\end{matrix} \begin{matrix}( inside of root : positive ) \\ ( otherthan above )\end{matrix} \qquad equation ( 3 )$$

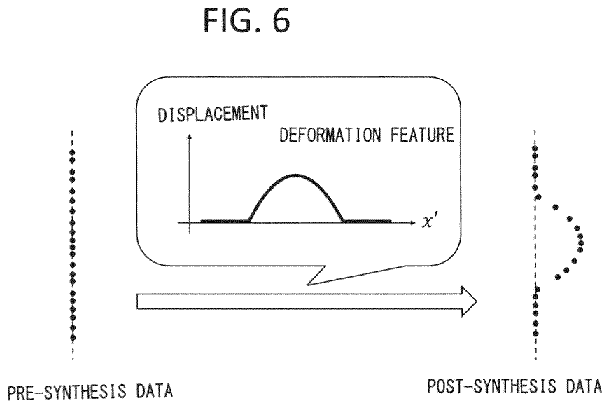

The deformation feature composition unit 140 has a function of composing (synthesizing) the deformation feature stored in the deformation feature database 130 for the input from the structure modeling unit 120. FIG. 6 is an explanatory diagram showing an example of a composition of deformation feature by the deformation feature composition unit 140.

The deformation feature composition unit 140 composes the original point cloud data with the deformation feature by giving each point a displacement corresponding to the amount of displacement d(x′,y′) shown in the balloon in FIG. 6, which corresponds to the (x′, y′) coordinates when each point belonging to the selected range is projected to the plane.

To perform composition, the deformation feature composition unit 140 moves each point in the direction of a normal vector of the plane by an amount equivalent to the displacement d(x′, y′), for example. The normal vector of the plane is calculated by the following equation (4) based on coefficients of the plane equation, for example.

$$[ Math 4 ]$$

$$\frac{1}{\sqrt{{a}^{2} + {b}^{2} + {c}^{2}}} \times ( a , b , c ) \qquad equation ( 4 )$$

The deformation feature composition unit 140 may overwrite the label information for each point with the value of the function L(x′, y′) corresponding to the (x′, y′) coordinates when each point is projected onto the plane. The deformation composition data generation apparatus 100 outputs point cloud data to which the deformation feature is composed as described above.

As described above, the deformation feature composition unit 140 in this example embodiment obtains the distribution of amount of displacement for the points in the point cloud data and composes the amount of displacement for the points in the point cloud data according to the distribution. The distribution is a distribution of amount of displacement of each point in the point cloud data from the model representing the shape formed by the point cloud data in an arbitrary range of the point cloud data.

The deformation composition range selection unit 110 selects an arbitrary range where composition is performed on the point cloud data. The structure modeling unit 120 generates a model for the selected arbitrary range in the point cloud data.

This model represents a planar structure. The structure modeling unit 120 generates a model by calculating the equation of the plane through which the point belonging to an arbitrary range selected in the point cloud data passes.

The distribution of amount of displacement is a distribution generated by calculating the amount of displacement from existing point cloud data. The distribution of amount of displacement may be a distribution defined by a mathematical formula that expresses the relationship between the coordinates of the points in the point cloud data and the amount of displacement.

The deformation feature database 130 stores the distribution of amount of displacement.

### Description of Operation

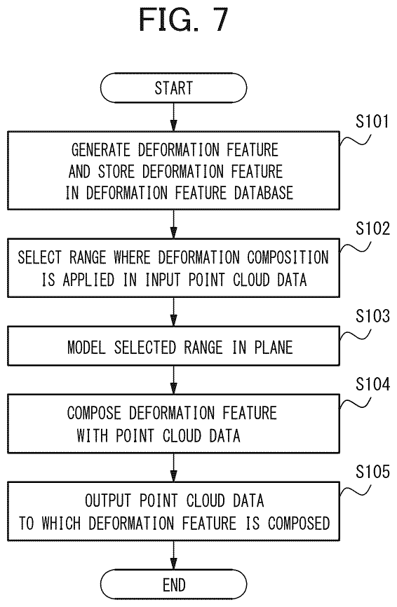

Hereinafter, the operation of the deformation composition data generation apparatus 100 of this example embodiment will be explained with reference to FIG. 7. FIG. 7 is a flowchart showing an operation of the deformation feature composition process by the deformation composition data generation apparatus 100 of the first example embodiment.

First, the deformation feature data generation apparatus 200 generates a function d(x′, y′) representing the distribution of amount of displacement as a deformation feature and a function L(x′, y′) representing label information. Next, the deformation feature data generation apparatus 200 stores the generated deformation feature in the deformation feature database 130 (step S101).

Next, the deformation composition range selection unit 110 selects a range where deformation composition is applied to the input point cloud data that is the target of deformation composition (step S102). Next, the deformation composition range selection unit 110 inputs the input original point cloud data and the selected range to the structure modeling unit 120.

Next, the structure modeling unit 120 models the selected range input from the deformation composition range selection unit 110 in a plane (step S103). Specifically, the structure modeling unit 120 calculates a plane equation through which the point belonging to the selected range input from the deformation composite range selection unit 110 passes.

Next, the structure modeling unit 120 calculates the (x′, y′) coordinates when each point belonging to the selected range is projected onto the plane represented by the calculated plane equation. The structure modeling unit 120 then inputs the input original point cloud data, the calculated plane equation, and the (x′, y′) coordinates of each point belonging to the selected range to the deformation feature composition unit 140.

Next, the deformation feature composition unit 140 composes the deformation feature stored in the deformation feature database 130 with the original point cloud data based on the input from the structure modeling unit 120 in step S101 (step S104).

Next, the deformation feature composition unit 140 outputs the point cloud data to which the deformation feature is composed (step S105). After outputting the data, the deformation feature composition process is completed by the deformation feature composition data generation apparatus 100.

### Description of Effects

The deformation composition data generation apparatus 100 in this example embodiment comprises the deformation composition range selection unit 110 that selects a range where deformation composition is applied to the input point cloud data, and the structure modeling unit 120 that calculates a plane structure that includes the points belonging to the selected range in the input point cloud data.

The deformation composition data generation apparatus 100 comprises the deformation feature database 130 that stores deformation features to be composed, and the deformation feature composition unit 140 that composes a deformation feature with the input point cloud data.

The deformation composition data generation apparatus 100 in this example embodiment focuses on the distribution of amount of displacement from a plane as a deformation feature. By using the method of moving each point so that the deformation feature is reproduced for other point cloud data, the deformation feature composition unit 140 can generate point cloud data to which the deformation including variation of a part of the object is composed.

As described above, the deformation composition data generation apparatus 100 can generate point cloud data with a deformation. When the generated point cloud data is used, it is expected to increase the diversity of the training data. The diversification of the training data contributes to the improvement of the detection performance of the training model to be constructed.

In addition, the deformation composition data generation apparatus 100 can reduce the amount of actual data required to construct a learning model of a given detection performance, thus lowering the cost of data collection.

### Example Embodiment 2

### Description of Configuration

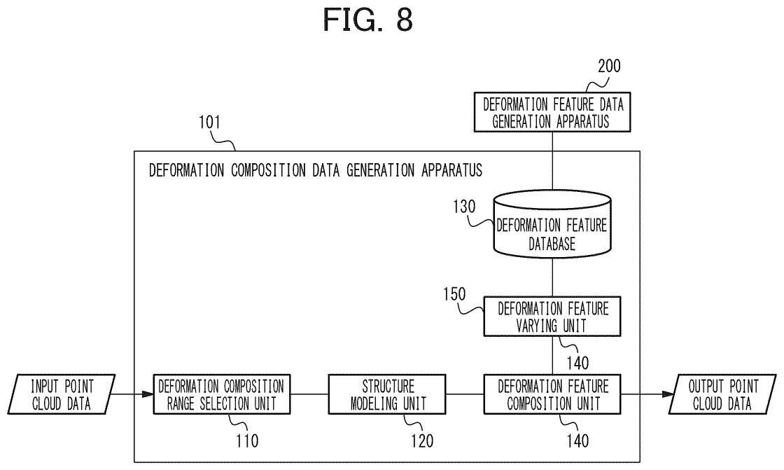

Next, the second example embodiment of the invention will be explained with reference to the drawings. FIG. 8 is a block diagram showing a configuration example the deformation composition data generation apparatus of the second example embodiment of the present invention.

The deformation composition data generation apparatus 101 shown in FIG. 8 comprises a deformation composition range selection unit 110, a structure modeling unit 120, a deformation feature database 130, a deformation feature composition unit 140, and a deformation feature varying unit 150.

As shown in FIG. 8, the deformation feature database 130 is communicatively connected to the deformation feature data generation apparatus 200. The deformation feature database 130 may not be connected to the deformation feature data generation apparatus 200.

The functions of the deformation composition range selection unit t 110, the structure modeling unit 120, the deformation feature database 130, and the deformation feature composition unit 140 in this example embodiment are the same as those in the first example embodiment, respectively.

The deformation feature varying unit 150 takes as input the deformation feature stored in the deformation feature database 130 and performs a variation process, such as enlargement and reduction, on the input deformation feature. The deformation feature varying unit 150 inputs the varied deformation feature to the deformation feature composition unit 140.

The deformation feature varying unit 150 performs the enlargement or reduction, which is an example of the variation process, as follows. When scaling up or down parallel to the plane direction, the deformation feature varying unit 150 sets the scale parameters in the x′ and y′ directions as sₓ, s_{y} respectively.

Next, the deformation feature varying unit 150 transforms the function d(x′, y′) representing the distribution of amount of displacement as d₁(x′, y′)=d(x′/sₓ, y′/s_{y}). When transforming, the deformation feature varying unit 150 is required to apply the same transformation to the function L(x′, y′) representing the label information.

When scaling up or down perpendicular to the plane direction, the deformation feature varying unit 150 transforms the function d(x′, y′) as d₂(x′, y′)=s_{z}d(x′, y′), with the scale parameter as s_{z}.

In addition to the enlargement or reduction, the deformation feature varying unit 150 can also perform rotations, inversions, etc. In addition, by restricting the definition range of the function, or by replacing d(x′, y′)=0 outside of a predetermined definition range, etc., the deformation feature varying unit 150 can extract only a portion of the deformation.

As the variation process other than the above, the deformation feature varying unit 150 may perform a variation process that changes the shape of the deformation by multiplying or adding some function f(x′, y′), such as d₃(x′, y′)=f(x′, y′)d(x′, y′) or d₄(x′, y′)=d(x′, y′)+f(x′, y′)

The function f(x′, y′) may be generated based on Perlin noise which is composed of smoothly varying random numbers, for example. The function f(x′, y′) may also be generated without random numbers. The function f(x′, y′) is not limited to a specific function, but may be any function that affects the function d(x′, y′) representing the distribution. The deformation feature varying unit 150 can also compose two or more deformation features by using a displacement extracted from another deformation as the function f(x′, y′).

The deformation feature varying unit 150 may use a combination of the multiple variation processes described above. The variation process is not limited to a specific process as long as it affects the function d(x′, y′) representing the distribution.

The deformation feature varying unit 150 once again sets the function d(x′, y′) using the function representing the distribution of amount of displacement after being transformed by the variation process, and sets the function L(x′, y′) using the function representing the label information after being transformed by the variation process. Next, the deformation feature varying unit 150 inputs the function d(x′, y′) and the function L(x′, y′) to the deformation feature composition unit 140.

As described above, the deformation feature varying unit 150 in this example embodiment performs a variation processing on the distribution of amount of displacement.

### Description of Operation

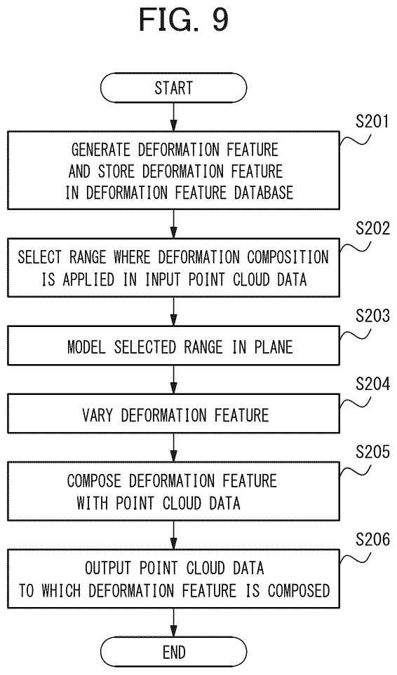

The operation of the deformation composition data generation apparatus 101 of this example embodiment will be explained with reference to FIG. 9. FIG. 9 is a flowchart showing an operation of the deformation feature composition process by the deformation composition data generation apparatus 101 of the second example embodiment.

Each process of steps S201 to S203 is the same as each process of steps S101 to S103 shown in FIG. 7.

Next, the deformation feature varying unit 150 takes a deformation feature stored in the deformation feature database 130 as input and performs the variation process on the input deformation feature (step S204). The deformation feature varying unit 150 inputs the deformation feature to which the variation process is applied to the deformation feature composition unit 140.

Next, the deformation feature composition unit 140 composes the original point cloud data with the deformation feature input from the deformation feature varying unit 150 in step S204, based on the input from the structure modeling unit 120 (step S205). The process of step S206 is the same as the process of step S105 shown in FIG. 7.

### Description of Effects

The deformation composition data generation apparatus 101 comprises a deformation feature varying unit 150 that performs the variation process such as the enlargement, reduction, etc., on a deformation feature. Since the deformation feature varying unit 150 can perform various variation processes on a deformation feature, the deformation composition data generation apparatus 101 can output a variety of point cloud data to which the deformation feature is composed. In other words, the deformation composition data generation apparatus 101 can further increase the diversity of the training data.

### Example Embodiment 3

### Description of Configuration

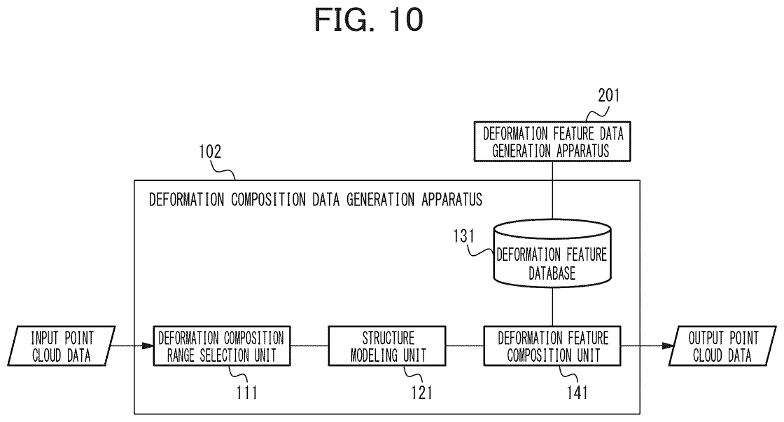

Next, a third example embodiment of the invention will be explained with reference to the drawings. FIG. 10 is a block diagram showing a configuration example the deformation composition data generation apparatus of the third example embodiment of the present invention.

The deformation composition data generation apparatus 102 shown in FIG. 10 comprises a deformation composition range selection unit 111, a structure modeling unit 121, a deformation feature database 131, and a deformation feature composition unit 141.

As shown in FIG. 10, the deformation feature database 131 is communicatively connected to the deformation feature data generation apparatus 201. The deformation feature database 131 does not have to be connected to the deformation feature data generation apparatus 201.

The deformation composition data generation apparatus 102 of this example embodiment is characterized by composing deformations not only for sites with a planar structure as in the first example embodiment, but also for sites with other geometric structures such as a cylinder (especially, side surfaces), a spherical surface, etc.

The functions of the deformation composition range selection unit 111, the structure modeling unit 121, the deformation feature database 131, and the deformation feature composition unit 141 are the same as those of the deformation composition range selection unit 110, the structure modeling unit 120, the deformation feature database 130, and the deformation feature composition unit 140 in the first example embodiment, respectively, except that they are not restricted to handling a planar structure.

The function of the deformation feature data generation apparatus 201 shown in FIG. 10 is the same as the function of the deformation feature data generation apparatus 200 in the first example embodiment, except that it is not limited to handling a planar structure.

Hereinafter, the differences between this example embodiment and the first example embodiment will be explained. In addition to sites with planar structures, the deformation composition range selection unit 111 may also use sites with other geometric structures, such as a cylinder and a spherical surface, as a range for selection. The deformation composition range selection unit 111 selects a range where deformation composition is applied to a manually identified geometric structure using point cloud processing software, for example.

Alternatively, the deformation composition range selection unit 111 may select a range where deformation composition is applied to the geometric structures extracted by the RANSAC-based algorithm described in Non-patent literature 3.

The structure modeling unit 121 has a function of modeling the selected range input from the deformation composite range selection unit 110 with a geometric structure. Specifically, the structure modeling unit 121 calculates an equation through which points belonging to the selected range input from the deformation composite range selection unit 111 pass, or parameters that characterize the geometric structure.

When the geometric structure is a plane, the structure modeling unit 121 calculates an equation in the form of equation (1). When the geometric structure is a spherical surface, the structure modeling unit 121 calculates equations in the form of equation (5).

$$[ Math 5 ]$$

$${( x - {x}_{0} )}^{2} + {( y - {y}_{0} )}^{2} + {( z - {z}_{0} )}^{2} = {r}^{2} \qquad equation ( 5 )$$

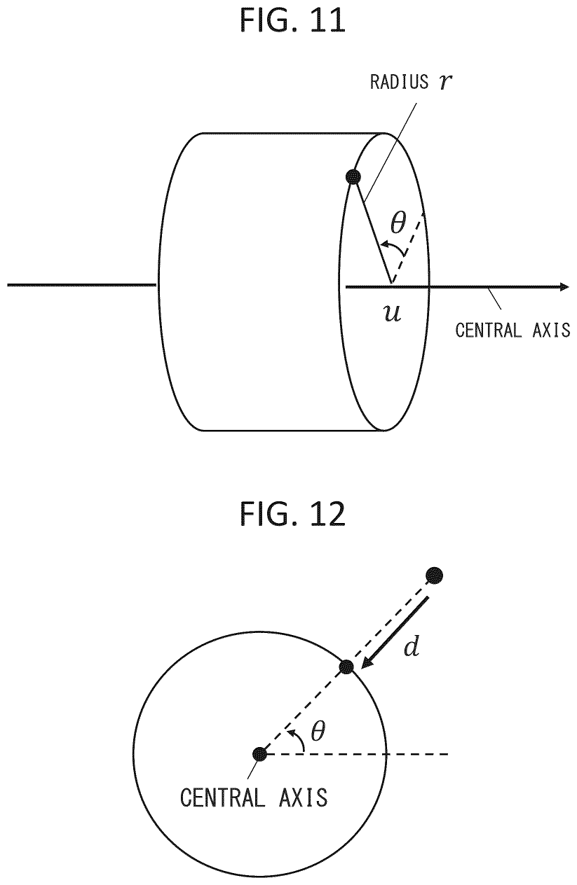

FIG. 11 is an explanatory diagram showing an example of a cylinder handled as a geometric structure by the deformation composition data generation apparatus 102. When the geometric structure is a cylinder, the structure modeling unit 121 can characterize the cylinder with a set of parameters such as a position and a direction of the central axis and a radius r.

After calculating the equation or the parameters, the structure modeling unit 121 defines the coordinate system on the geometric structure. In the first example embodiment, the orthogonal coordinate system corresponded to the coordinate system on the geometric structure (plane).

When the geometric structure is a cylinder rather than a plane, each point on the cylinder is represented by a pair of a position u on the central axis and an angle θ shown in FIG. 11. In other words, the structure modeling unit 121 can use (u, θ) coordinates.

Alternatively, the structure modeling unit 121 can use (u, l) coordinates where the arc length l=rθ is used instead of the angle. It is considered that (u, l) coordinates are more likely to represent information such as the size of the deformation.

After defining the coordinate system on the geometric structure, the structure modeling unit 121 calculates the coordinates when the points are projected onto the geometric structure as shown in FIG. 12 for each point belonging to the selected range. FIG. 12 is an explanatory diagram showing an example of a projection of points belonging to a selected range onto a geometric structure by the structure modeling unit 121.

The deformation features stored in the deformation feature database 131 in this example embodiment are functions in the coordinate system on the geometric structure in which the amount of displacement from the geometric structure is expressed.

The deformation feature extraction unit 230 in this example embodiment can define the amount of displacement from the geometric structure as the Euclidean distance between the point after being projected onto the geometric structure and the original point, for example. d shown in FIG. 12 corresponds to the Euclidean distance. The deformation feature extraction unit 230 may define the amount of displacement from the geometric structure as a signed distance with a sign that is negative inward and positive outward.

As in the first example embodiment, when each point has label information, which is information such as presence or absence of an alteration, type of alteration, or scale of alteration, the deformation feature extraction unit 230 also defines a function representing the label information.

When the (u, l) coordinate system is used, the deformation feature extraction unit 230 stores the function d(u, l) representing the distribution of amount of displacement and the function L(u, l) representing label information in the deformation feature database 131 as a deformation feature. The deformation feature data generation apparatus 201, which function is not limited to handling a planar structure, can generate the above deformation feature from existing point cloud data with deformations.

When the (u, l) coordinate system is used, the deformation feature composition unit 141 composes the original point cloud data with the deformation feature by giving each point a displacement corresponding to the amount of displacement d(u, l) corresponding to the (u, l) coordinate when each point belonging to the selected range is projected onto the geometric structure.

To perform composition, the deformation feature composition unit 141 moves each point in the direction of the normal vector of the geometric structure by an amount equivalent to the amount of displacement d(u, l), for example. It should be noted that unlike the normal vector of the plane represented by equation (4), the normal vector of a general geometric structure is position-dependent.

For example, for a cylinder whose central axis is equal to the z-axis, the normal vector is calculated as (cosθ, sinθ, 0). If the central axis is different from the z-axis, the normal vector is rotated by the different amount.

As described above, the model in this example embodiment represents a geometric structure such as a spherical surface or cylinder. The structure modeling unit 121 in this example embodiment generates the model by calculating the equation of a spherical surface or cylinder through which points belonging to an arbitrary range selected in the point cloud data, or parameters that characterize the geometric structure.

### Description of Operation

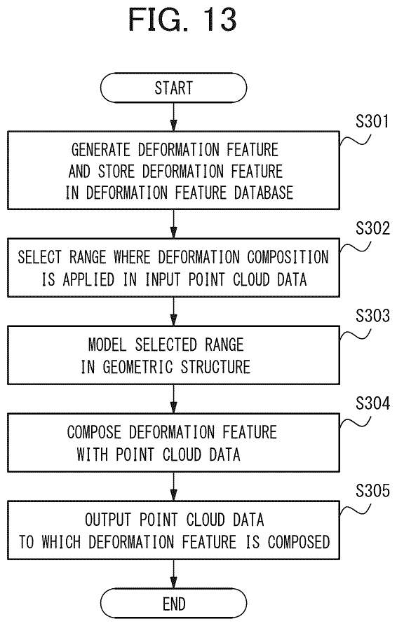

Hereinafter, an operation of the deformation composition data generation apparatus 102 of this example embodiment is explained with reference to FIG. 13. FIG. 13 is aa flowchart showing an operation of the deformation feature composition process by the deformation composition data generation apparatus 102 of the third example embodiment.

Each process of steps S301 to S304 is the same as each process of steps S101 to S104 shown in FIG. 7, except that they are not limited to handling a planar structure. The process of step S305 is the same as the process of step S105 shown in FIG. 7.

### Description of Effects

The deformation composition data generation apparatus 102 of this example embodiment can composite deformations on more types of sites than the first example embodiment by not limiting the target of compositing deformations to sites having a planar structure. For example, the deformation composition data generation apparatus 102 of this example embodiment can compose deformations on the piers of a bridge whose shape is a circular cylinder.

### Example Embodiment 4

### Description of Configuration

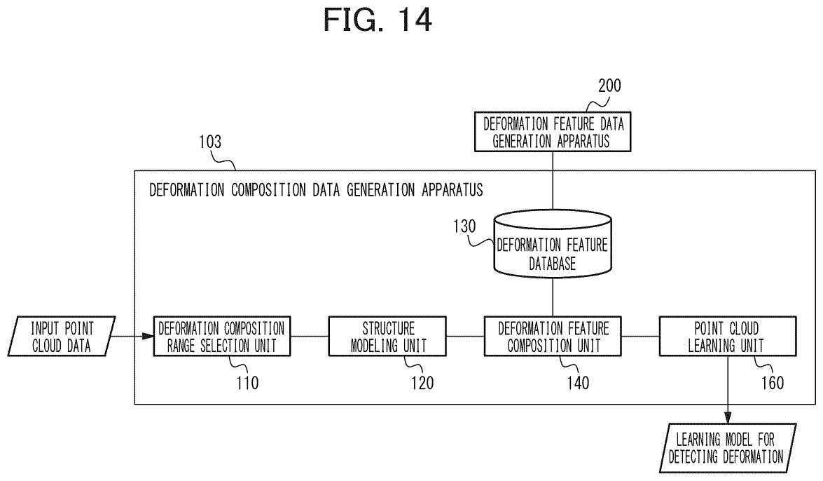

Next, a fourth example embodiment of the invention will be explained with reference to the drawings. FIG. 14 is a block diagram showing a configuration example the deformation composition data generation apparatus of the fourth example embodiment of the present invention.

The deformation composition data generation apparatus 103 shown in FIG. 14 comprises a deformation composition range selection unit 110, a structure modeling unit 120, a deformation feature database 130, a deformation feature composition unit 140, and a point cloud learning unit 160.

As shown in FIG. 14, the deformation feature database 130 is communicatively connected to the deformation feature data generation apparatus 200. The deformation feature database 130 may not be connected to the deformation feature data generation apparatus 200.

The functions of the deformation composition range selection unit 110, the structure modeling unit 120, the deformation feature database 130, and the deformation feature composition unit 140 in this example embodiment are the same as those in the first example embodiment, respectively. It is preferable that the point cloud data output by the deformation feature composition unit 140 is not only one, but multiple point cloud data to which deformations of various shapes are composed.

The point cloud learning unit 160 has a function to execute machine learning using the point cloud data output by the deformation feature composition unit 140 as training data to construct a machine learning model or deep learning model to determine whether or not there is a deformation or to identify the location of a deformation.

Instead of using only the synthetic data output by the deformation feature composition unit 140 as training data, the point cloud learning unit 160 may use as training data a mixture of data that has deformations from the original and synthetic data.

The point cloud learning unit 160 construct a machine learning network or a deep learning network as a machine learning model or a deep learning models, for example. The machine learning network or deep learning network that uses point cloud data as input is, for example, PointNet++ described in Non-patent literature 4.

The point cloud learning unit 160 outputs a constructed machine learning model or deep learning model after the learning is completed. The learning model output by the point cloud learning unit 160 is a learning model for detecting deformation that can detect deformities.

As described above, the point cloud learning unit 160 in this example embodiment constructs a learning model by performing machine learning using point cloud data with composed the amount of displacement as training data.

### Description of Operation

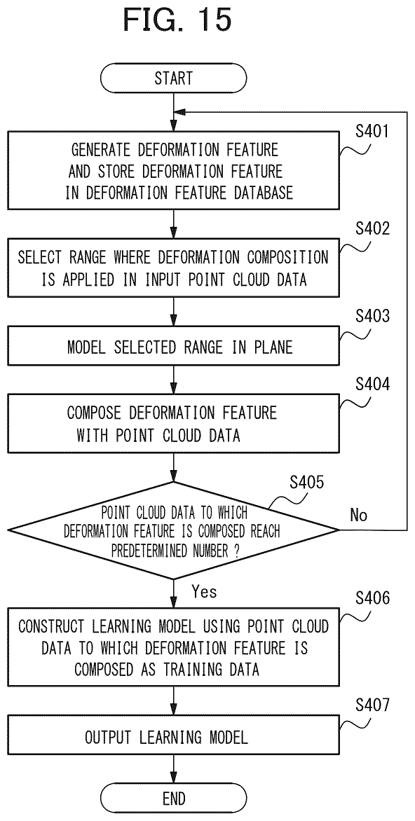

The operation of the deformation composition data generation apparatus 103 of this example embodiment is explained below with reference to FIG. 15. FIG. 15 is a flowchart showing an operation of the deformation feature composition process by the deformation composition data generation apparatus 103 of the fourth example embodiment.

Each process of steps S401 to S404 is the same as each process of steps S101 to S104 shown in FIG. 7.

The deformation feature composition unit 140 determines whether or not the number of point cloud data to which the deformation feature is composed reaches a predetermined number (step S405). When the point cloud data to which the deformation feature is composed have been composed has not reached the predetermined number (No in step S405), the deformation composition data generation apparatus 103 repeatedly executes each process of steps S401 to S404.

By repeatedly executing each process of steps S401 to S404, the deformation composition data generation apparatus 103 can generate multiple point cloud data to which deformations of various shapes are composed. The process of step S401 may be omitted as appropriate.

When the number of point cloud data to which the deformation feature is composed reaches a predetermined number (Yes in step S405), the deformation feature composition unit 140 inputs the plurality of point cloud data to which the deformation feature is composed to the point cloud learning unit 160. The point cloud learning unit 160 constructs a machine learning model or a deep learning model using the point cloud data input from the deformation feature composition unit 140 as training data (step S406).

Next, the point cloud learning unit 160 outputs the machine learning model or deep learning model constructed in step S406 (step S407). After outputting, the deformation composition data generation apparatus 103 terminates the deformation feature composition process.

### Description of Effects

The deformation composition data generation apparatus 103 of this example embodiment comprises the point cloud learning unit 160 that uses the point cloud data output by the deformation feature composition unit 140 as learning data to construct a learning model for detecting deformations. By using multiple point cloud data composed with a variety of deformations as learning data, the point cloud learning unit 160 can improve the performance of machine learning models and deep learning models that determine whether or not there is a deformation or identify the location of a deformation.

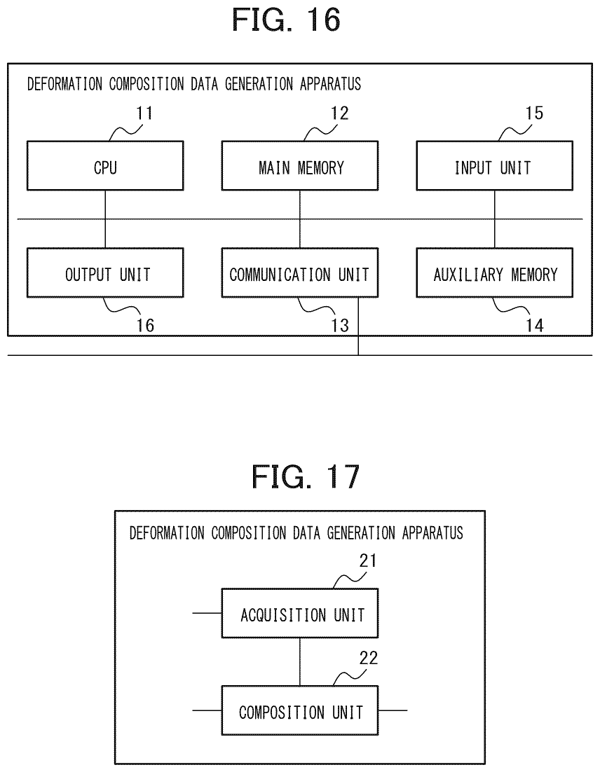

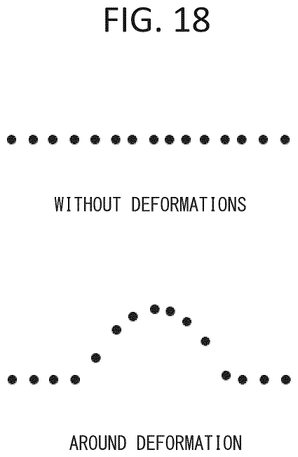

Hereinafter, specific examples of hardware configurations of each example embodiment of deformation composition data generation apparatuses 100 to 103 will be explained. FIG. 16 is an explanatory diagram showing an example of the hardware configuration of the deformation composition data generation apparatus according to the present invention.

The deformation composition data generation apparatus shown in FIG. 16 comprises a CPU (Central Processing Unit) 11, a main memory 12, a communication unit 13, and an auxiliary memory 14. It also has an input unit 15 for user operation and an output unit 16 for presenting the processing results or progress of the processing to the user.

The deformation composition data generation apparatus is realized by software, whereby the CPU 11 shown in FIG. 16 executes a program that provides the functions of respective components.

In other words, each function is realized by software when CPU 11 loads the program stored in auxiliary memory 14 into main memory 12 and executes the program to control the operation of the deformation composition data generation apparatus.

The deformation composition data generation apparatus shown in FIG. 16 may include a DSP (Digital Signal Processor) instead of CPU 11. Alternatively, the deformation composition data generation apparatus shown in FIG. 16 may include both CPU 11 and DSP.

The main memory 12 is used as a working area for data and as a temporary storage area for data. The main memory 12 is, for example, RAM (Random Access Memory). The deformation feature databases 130 to 131 is realized in the main memory 12.

The communication unit 13 has a function of inputting and outputting data to and from peripheral devices through a wired or wireless network (information communication network).

The auxiliary storage 14 is a non-transitory tangible storage medium. There are a magnetic disk, an optical disk, a CD-ROM (Compact Disk Read Only Memory), a DVD-ROM (Digital Versatile Disk Read Only Memory), and a semiconductor memory as examples of non-transitory tangible storage media.

The input unit 15 has a function of inputting data and processing instructions. The input unit 15 is an input device such as a keyboard or a mouse, for example.

The output unit 16 has a function of outputting data. The output unit 16 is a display device such as a liquid crystal display device or a printing device such as a printer, for example.

As shown in FIG. 16, each component is connected to a system bus 17 in the deformation composition data generation apparatus.

In the deformation composition data generation apparatus 100 of the first example embodiment, the auxiliary memory 14 stores a program for realizing the deformation composition range selection unit 110, the structure modeling unit 120, and the deformation feature composition unit 140.

The deformation composition data generation apparatus 100 may be implemented with circuits containing hardware components such as an LSI (Large Scale Integration) that realizes the functions shown in FIG. 1 on the inside, for example.

In the deformation composition data generation apparatus 101 of the second example embodiment, the auxiliary memory 14 stores a program for realizing the deformation composition range selection unit 110, the structure modeling unit 120, the deformation feature composition unit 140, and the deformation feature varying unit 150.

The deformation composition data generation apparatus 101 may be implemented with circuits containing hardware components such as an LSI that realizes the functions shown in FIG. 8 on the inside, for example.

In the third example embodiment of the deformation composition data generation apparatus 102, the auxiliary storage unit 14 stores a program for realizing the deformation composition range selection unit 111, the structure modeling unit 121, and the deformation feature composition unit 141.

The deformation composition data generation apparatus 102 may be implemented with circuits containing hardware components such as an LSI that realizes the functions shown in FIG. 10 on the inside, for example.

In the fourth example embodiment of the deformation composition data generation apparatus 103, the auxiliary memory 14 stores a program for realizing the deformation composition range selection unit 110, the structure modeling unit 120, the deformation feature composition unit 140, and the point cloud learning unit 160.

The deformation composition data generation apparatus 103 may be implemented with circuits containing hardware components such as an LSI that realizes the functions shown in FIG. 14 on the inside, for example.

The deformation composition data generation apparatuses 100 to 103 may be realized by hardware that does not include computer functions using elements such as a CPU. For example, a part or all of components may be realized by general-purpose circuits (circuitry) or dedicated circuits, processors, etc. or a combination thereof. They may be configured by a single chip (for example, the LSI described above) or by multiple chips connected through a bus. A part or all of components may be realized by a combination of the above-mentioned circuits, etc. and a program.

A part or all of components of the deformation composition data generation apparatuses 100 to 103 may be configured one or more information processing devices comprising an operation unit and a storage unit.

When some or all of components are realized by multiple information processing devices or circuits, etc., the multiple information processing devices or circuits, etc. may be centrally located or distributed. For example, the information processing device and circuits, etc. may be realized as a client-and-server system, a cloud computing system, etc., each of which is connected through a communication network.

Next, an overview of this invention will be explained. FIG. 17 is a block diagram showing an overview of the deformation composition data generation apparatus according to the present invention. The deformation composition data generation apparatus 20 according to the present invention comprises an acquisition unit 21 (for example, the deformation feature composition unit 140) that acquires a distribution of amount of displacement for points in point cloud data, and a composition unit 22 (for example, the deformation feature composition unit 140) that composes the amount of displacement to the points in the point cloud data according to the distribution.

The distribution is a distribution of amount of displacement of each point in the point cloud data from a model representing a shape formed by the point cloud data in any range of the point cloud data. The distribution of amount of displacement may be a distribution generated by calculating the amount of displacement from existing point cloud data. The distribution of amount of displacement may also be a distribution defined by a mathematical formula that expresses a relationship between coordinates of the points in the point cloud data and the amount of displacement.

With such a configuration, the deformation composition data generation apparatus can generate new data with a deformation even if the data format is a point cloud.

The deformation composition data generation apparatus 20 may further comprise a selection unit (for example, the deformation composite range selection unit 110) which selects the range where composition is performed on the point cloud data. The deformation composition data generation apparatus 20 may further comprise a generating unit (for example, the structure modeling unit 120) which generates the model for the selected range from the point cloud data.

With such a configuration, the deformation composition data generation apparatus can generate new data with deformations based on any range in the point cloud data.

The model may represent a planar structure, and the generation apparatus may generate the model by calculating an equation of a plane through which the points belonging to the range selected from the point cloud data pass.

With such a configuration, the deformation composition data generation apparatus can generate new data with a deformation based on point cloud data representing a plane.

The model may represent the geometric structure of a spherical surface or cylinder, and the generation unit may generate the model by calculating an equation of the spherical surface or cylinder through which the points belonging to the range selected from the point cloud data pass, or a parameter characterizing the geometric structure.

With such a configuration, the deformation composition data generation apparatus can generate new data with a deformation based on point cloud data representing the spherical surface or cylinder.

The deformation composition data generation apparatus 20 may further comprises a varying unit (for example, the deformation feature varying unit 150) which performs a variation process on the distribution of amount of displacement.

With such a configuration, the deformation composition data generation apparatus can further increase the diversity of the training data.

The deformation composition data generation apparatus 20 may further comprise a learning unit (for example, the point cloud learning unit 160) which constructs a learning model by performing machine learning using the point cloud data to which the amount of displacement is composed as training data.

With such a configuration, the deformation composition data generation apparatus can construct a machine learning model or deep learning model to determine whether there is a deformation or not, or to identify the location of a deformation.

The deformation composition data generation apparatus 20 may further comprise a memory (for example, the deformation feature database 130) which stores the distribution of amount of displacement.

A part of or all of the above example embodiments may also be described as, but not limited to, the following supplementary notes.

(Supplementary note 1) A deformation composition data generation apparatus comprising:
an acquisition unit which acquires a distribution of amount of displacement for points in point cloud data, and
a composition unit which composes the amount of displacement to the points in the point cloud data according to the distribution.

(Supplementary note 2) The deformation composition data generation apparatus according to Supplementary note 1, wherein
the distribution is a distribution of amount of displacement of each point in the point cloud data from a model representing a shape formed by the point cloud data in any range of the point cloud data.

(Supplementary note 3) The deformation composition data generation apparatus according to Supplementary note 2, further comprising
a selection unit which selects the range where composition is performed on the point cloud data.

(Supplementary note 4) The deformation composition data generation apparatus according to Supplementary note 3, further comprising
a generation unit which generates the model for the selected range from the point cloud data.

(Supplementary note 5) The deformation composition data generation apparatus according to Supplementary note 4, wherein
the model represents a planar structure, and
the generation unit generates the model by calculating an equation of a plane through which the points belonging to the range selected from the point cloud data pass.

(Supplementary note 6) The deformation composition data generation apparatus according to Supplementary note 4, wherein
the model represents a geometric structure of a spherical surface or cylinder, and
the generation unit generates the model by calculating an equation of the spherical surface or cylinder through which the points belonging to the range selected from the point cloud data pass, or a parameter characterizing the geometric structure.

(Supplementary note 7) The deformation composition data generation apparatus according to any one of Supplementary notes 1 to 6, further comprising
a varying unit which performs a variation process on the distribution of amount of displacement.

(Supplementary note 8) The deformation composition data generation apparatus according to any one of Supplementary notes 1 to 7, further comprising
a learning unit which constructs a learning model by performing machine learning using the point cloud data to which the amount of displacement is composed as training data.

(Supplementary note 9) The deformation composition data generation apparatus according to any one of Supplementary notes 1 to 8, further comprising
a memory which stores the distribution of amount of displacement.

(Supplementary note 10) The deformation composition data generation apparatus according to any one of Supplementary notes 1 to 9, wherein
the distribution of amount of displacement is a distribution generated by calculating an amount of displacement from existing point cloud data.

(Supplementary note 11) The deformation composition data generation apparatus according to any one of Supplementary notes 1 to 9, wherein
the distribution of amount of displacement is a distribution defined by a mathematical formula that expresses a relationship between coordinates of the points in the point cloud data and the amount of displacement.

(Supplementary note 12) A deformation composition data generation method comprising:
acquiring a distribution of amount of displacement for points in point cloud data, and
composing the amount of displacement to the points in the point cloud data according to the distribution.

(Supplementary note 13) A computer readable recording medium storing a deformation composition data generation program causing a computer to execute:
acquiring a distribution of amount of displacement for points in point cloud data, and
composing the amount of displacement to the points in the point cloud data according to the distribution.

Although the invention of the present application has been described above with reference to example embodiments, the present invention is not limited to the above example embodiments. Various changes can be made to the configuration and details of the present invention that can be understood by those skilled in the art within the scope of the present invention.

### INDUSTRIAL APPLICABILITY

The present invention is suitable for the development of machine learning models and deep learning models for detecting damage such as cracks, delamination and exposed rebar in infrastructure facilities such as bridges, tunnels, concrete buildings, etc., from point cloud data.

### REFERENCE SIGNS LIST

11 CPU
12 Main memory
13 Communication unit
14 Auxiliary memory
15 Input unit
16 Output unit
17 System bus
20, 100-103 Deformation composition data generation apparatus
21 Acquisition unit
22 Composition unit
110, 111 Deformation composition range selection unit
120, 121, 220 Structure modeling unit
130, 131 Deformation feature database
140, 141 Deformation feature composition unit
150 Deformation feature varying unit
160 Point Cloud Learning Dept,
200, 201 Deformation feature data generation apparatus
210 Deformation extraction range selection unit
230 Deformation feature extraction unit

What is claimed is:

1. A deformation composition data generation apparatus comprising:
a memory storing software instructions, and
one or more processors configured to execute the software instructions to acquire a distribution of amount of displacement for points in point cloud data, and
compose the amount of displacement to the points in the point cloud data according to the distribution.

2. The deformation composition data generation apparatus according to claim 1, wherein
the distribution is a distribution of amount of displacement of each point in the point cloud data from a model representing a shape formed by the point cloud data in any range of the point cloud data.

3. The deformation composition data generation apparatus according to claim 2,
wherein the one or more processors are further configured to execute the software instructions to
select the range where composition is performed on the point cloud data.

4. The deformation composition data generation apparatus according to claim 3,
wherein the one or more processors are further configured to execute the software instructions to
generate the model for the selected range from the point cloud data.

5. The deformation composition data generation apparatus according to claim 4, wherein
the model represents a planar structure, and
the one or more processors are configured to execute the software instructions to generate the model by calculating an equation of a plane through which the points belonging to the range selected from the point cloud data pass.

6. The deformation composition data generation apparatus according to claim 4, wherein
the model represents a geometric structure of a spherical surface or cylinder, and
the one or more processors are configured to execute the software instructions to generate the model by calculating an equation of the spherical surface or cylinder through which the points belonging to the range selected from the point cloud data pass, or a parameter characterizing the geometric structure.

7. The deformation composition data generation apparatus according to claim 1,
wherein the one or more processors are further configured to execute the software instructions to
perform a variation process on the distribution of amount of displacement.

8. The deformation composition data generation apparatus according to claim 1,
wherein the one or more processors are further configured to execute the software instructions to
construct a learning model by performing machine learning using the point cloud data to which the amount of displacement is composed as training data.

9. The deformation composition data generation apparatus according to claim 1, further comprising
a memory which stores the distribution of amount of displacement.

10. The deformation composition data generation apparatus according to claim 1, wherein
the distribution of amount of displacement is a distribution generated by calculating an amount of displacement from existing point cloud data.

11. The deformation composition data generation apparatus according to claim 1, wherein
the distribution of amount of displacement is a distribution defined by a mathematical formula that expresses a relationship between coordinates of the points in the point cloud data and the amount of displacement.

12. A deformation composition data generation method comprising:
acquiring a distribution of amount of displacement for points in point cloud data, and
composing the amount of displacement to the points in the point cloud data according to the distribution.

13. A non-transitory computer readable recording medium storing a deformation composition data generation program causing a computer to execute:
acquiring a distribution of amount of displacement for points in point cloud data, and
composing the amount of displacement to the points in the point cloud data according to the distribution.
